(19) United States
(12) Patent Application Publication
(10) Pub. No.: US 2019/0031160 A1
(43) Pub. Date: Jan. 31, 2019

(54) Active Duct System For An Automotive Vehicle

(71) Applicant: GM GLOBAL TECHNOLOGY OPERATIONS LLC, Detroit, MI (US)

(72) Inventors: Ethan A. McMillan, Oak Park, MI (US); Rebecca Tjoelker, Commerce Charter Township, MI (US)

(21) Appl. No.: 15/659,745

(22) Filed: Jul. 26, 2017

(51) Int. Cl. B60T 5/00; B62D 35/00; F16D 66/00

(52) U.S. Cl. CPC B60T 5/00; B62D 35/005; B60Y 2400/405; F16D 2066/001; F16D 66/00

(57) ABSTRACT

An automotive vehicle includes a wheel well having an inboard portion and an outboard portion. The vehicle also includes a duct associated with a duct inlet, a first duct outlet, and a second duct outlet. The duct inlet is configured to receive airflow resulting from vehicle motion. The first duct outlet is disposed at the inboard portion of the wheel well, and the second duct outlet is disposed at the outboard portion of the wheel well. The duct has a branch portion, a first length coupling the duct inlet to the branch portion, a second length coupling the branch portion to the first duct outlet, and a third length coupling the branch portion to the second duct outlet. The vehicle further includes a movable member disposed proximate the branch portion for controlling the fractions of airflow from the first length into the second and third lengths, respectively.

### TECHNICAL FIELD

The present disclosure relates to automotive vehicles, and more particularly to aerodynamic features of automotive vehicles.

### INTRODUCTION

Modern automotive vehicles typically have hydraulically actuated brakes on both the front and rear wheels of the vehicle. In vehicle disc brake systems, the hub of the vehicle wheel is mounted to an axially concentric, circular disc formed of a thermally conductive and wear resistant metal. A brake caliper, fixed to the vehicle, fits around a sector of the circular disc. When a vehicle operator steps on the brake pedal, hydraulic fluid is pressurized in a brake hose connected to the brake caliper and forces friction material pads of the brake caliper against both sides of the rotating wheel disc. The frictional engagement between the caliper pads and the rotating disc serves to slow, and possibly stop, the vehicle wheel. In drum brake systems, the vehicle wheel has an axially concentric, circular metal drum surface of thermally conductive and wear resistant metal. When braking is called for, pressurized hydraulic fluid in a brake hose forces arcuate brake linings of suitable friction material outwardly against the wheel drum, to again slow, and possibly stop, the vehicle wheel.

For styling, and to control the dispersion of sand, mud, liquids, and other road spray picked up by the rotating tire, vehicle wheels are generally partially enclosed within the vehicle body within a wheel well. The wheel well is a generally circular, partially closed cavity, open at its underside and at a vehicle fender or quarter panel and extending part-way into the vehicle body. Contained within the wheel well will be the wheel, brake assembly and, often, some suspension components such as springs and shock absorbers. The wheel well is sized to accommodate the wheel and tire in all configurations which they may adopt and so its design admits of the expected range of tire movements. These may include the suspension travel and, for the front wheels, the expected range of angular inclinations on turning the steering wheel. Commonly the wheel well will be generally closed at the vehicle interior and around an appreciable portion of the tire circumference.

Generally airflow around a moving vehicle contributes significantly to the cooling of brake disc and brake drum surfaces when they are heated by the repeated wheel braking actions of normal driving. This airflow is usually more than sufficient to cool brake discs, drums, and friction materials under most commonly-experienced driving conditions, although some extra operator care might be required when towing a trailer or when driving in mountainous regions with long, steep grades. However, vehicle hood, roof, rear deck, and side surfaces are being designed with greater emphasis on reducing vehicle drag. Some design features included for drag reduction, such as air dams, may reduce the flow of air available for cooling frictionally heated brake member surfaces.

### SUMMARY

An automotive vehicle according to the present disclosure includes a body having a fore portion and an aft portion. The vehicle additionally includes a wheel well having an inboard portion and an outboard portion. The vehicle also includes a duct associated with a duct inlet, a first duct outlet, and a second duct outlet. The duct inlet is disposed at the fore portion, and is configured to receive airflow resulting from vehicle motion. The first duct outlet is disposed at the inboard portion of the wheel well, and the second duct outlet is disposed at the outboard portion of the wheel well. The duct has a branch portion, a first length coupling the duct inlet to the branch portion, a second length coupling the branch portion to the first duct outlet, and a third length coupling the branch portion to the second duct outlet. The vehicle further includes a movable member disposed proximate the branch portion. The movable member is movable between a first position and a second position. In the first position a first fraction of the airflow is directed from the first length into the second length, and in the second position a second fraction of the airflow is directed from the first length into the second length.

In an exemplary embodiment, the vehicle additionally includes an electromechanical actuator coupled to the movable member and configured to drive the movable member between the first position and the second position. Such embodiments may additionally include a vehicle brake assembly, a thermal sensor configured to detect a current temperature of the vehicle brake assembly, and a controller. The controller is configured to control the actuator to move the movable member from the first position to the second position in response to the current temperature exceeding a first predefined threshold. The controller may be further configured to control the actuator to move the movable member from the second position to the first position in response to the current temperature falling below a second predefined threshold. The second predefined threshold may be less than the first predefined threshold.

In an exemplary embodiment, the vehicle additionally includes a vehicle wheel disposed in the wheel well. In such embodiments, the first duct outlet is disposed inboard of the vehicle wheel and the second duct outlet is disposed outboard of the vehicle wheel.

A method of controlling an automotive vehicle according to the present disclosure includes providing the vehicle with a wheel well having an inboard portion and an outboard portion. The method also includes providing the vehicle with a duct having an inlet opening to the exterior of the vehicle, a first outlet opening to the exterior of the vehicle at the inboard portion, and a second outlet opening to the exterior of the vehicle at the outboard portion. The first outlet and second outlet are in fluid communication with the inlet. The method also includes receiving air via the inlet during vehicle motion. The method also includes directing a first fraction of the air to the second outlet. The method also includes in response to satisfaction of an operating condition, directing a second fraction of the air to the second outlet. The second fraction is different from the first fraction.

In an exemplary embodiment, the method further includes providing a movable member in the duct. The movable member has a first position and a second position, and directing a second fraction of air to the second outlet includes moving the movable member from the first position to the second position. In such embodiments, the method may further include providing an actuator associated with the movable member, where moving the movable member from the first position to the second position includes controlling the actuator to drive the movable member from the first position to the second position. Such embodiments may further include providing the vehicle with a brake assembly, where the operating condition includes a current temperature of the brake assembly exceeding a first predefined threshold.

In an exemplary embodiment, the method further includes, in response to the current temperature falling below a second predefined threshold, directing the first fraction of the air to the second outlet. The second predefined threshold may be less than the first predefined threshold.

In an exemplary embodiment, the operating condition includes a brake request.

A duct assembly for a vehicle, includes a first duct portion, a second duct portion, and a third duct portion. The duct assembly also includes a branch portion coupling the first duct portion to the second duct portion and the third duct portion. The duct assembly also includes an inlet coupled to the first duct portion and fluidly coupling the first duct portion to the exterior of the vehicle. The duct assembly also includes a first outlet coupled to the second duct portion and fluidly coupling the second duct portion to the exterior of the vehicle, the first outlet being disposed at an inboard portion of a wheel well. The duct assembly also includes a second outlet coupled to the third duct portion and fluidly coupling the third duct portion to the exterior of the vehicle, the second outlet being disposed at an outboard portion of the wheel well. The duct assembly also includes a valve assembly associated with the branch portion and configured to selectively vary a fraction of airflow from the first duct portion to the second duct portion.

In an exemplary embodiment, the valve assembly includes a movable member disposed at the branch portion and being movable between a first position and a second position. In the first position a first fraction of airflow is directed from the first duct portion into the second duct portion, and in the second position a second fraction of airflow is directed from the first duct portion into the second duct portion. The valve assembly may further include an electromechanical actuator coupled to the movable member and configured to drive the movable member between the first position and the second position. The duct assembly may further include a controller configured to control the actuator to move the movable member from the first position to the second position in response to a measured temperature exceeding a first predefined threshold. The controller may be further configured to control the actuator to move the movable member from the second position to the first position in response to the measured temperature falling below a second predefined threshold. The second predefined threshold may be below the first predefined threshold.

Embodiments according to the present disclosure provide a number of advantages. For example, the present disclosure provides a system and method for satisfying brake cooling requirements of a performance automotive vehicle while also reducing vehicle drag.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a top view of an automotive vehicle according to an embodiment of the present disclosure;

FIG. 2 is a front view of an automotive vehicle according to an embodiment of the present disclosure;

FIG. 3 is a view of a duct assembly according to an embodiment of the present disclosure;

FIG. 4 is a schematic representation of a duct assembly according to an embodiment of the present disclosure; and

FIG. 5 is a flowchart representation of a method of controlling an automotive vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desirable for particular applications or implementations.

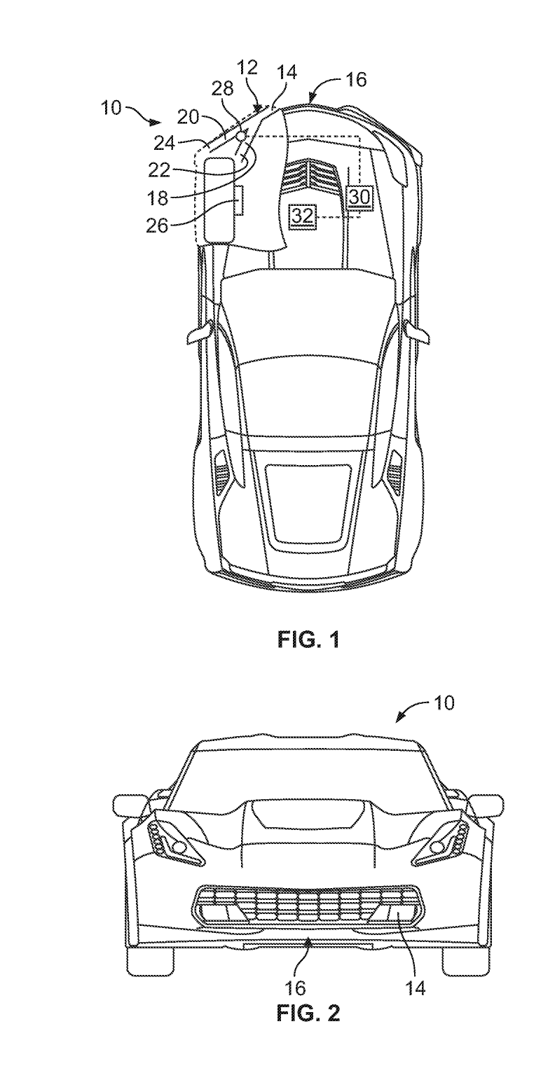

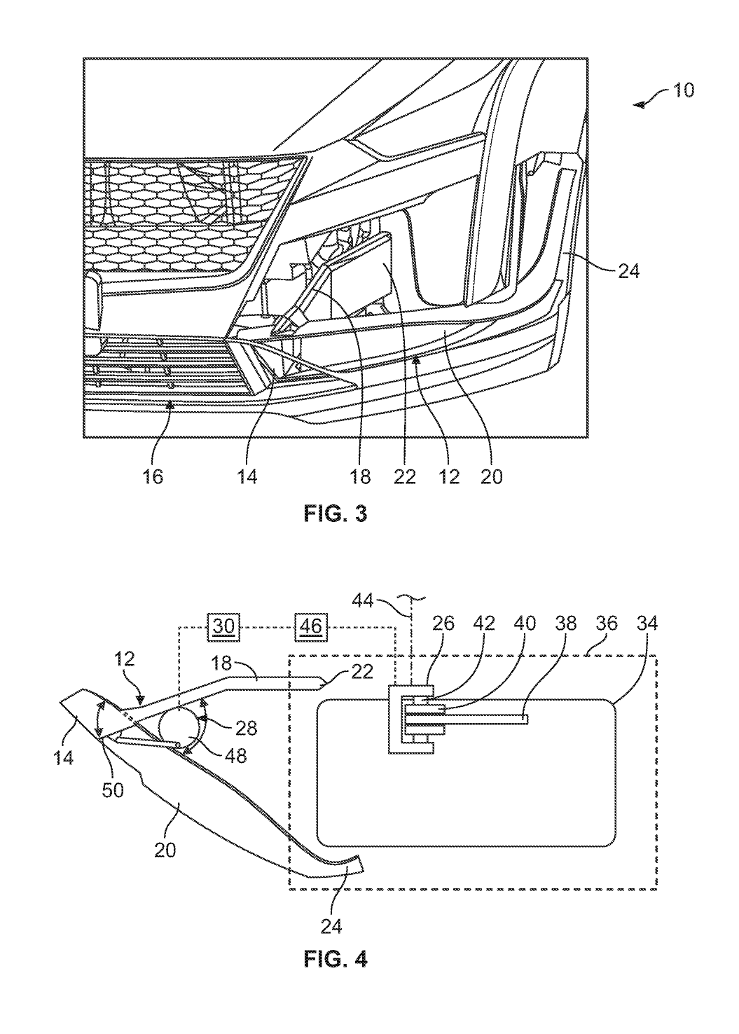

Referring now to FIGS. 1, 2, and 3, an automotive vehicle 10 according to the present disclosure is illustrated. The automotive vehicle is provided with a duct 12 having an inlet 14. The inlet 14 is positioned at a location on the vehicle body which experiences higher air pressure than the wheel wells. As used here, a wheel well refers to a volume extending inwardly from an opening in a vehicle body sides to form a generally semi-circular, partially open cavity for retaining a vehicle wheel. In many vehicles the wheel wells are subject to a reduced pressure so that cooling air drawn may be drawn from many body locations and ‘sucked into’ the wheel wells. It is preferred, to increase flow, that the inlet be located in a region of the body where the air pressure is greater than the pressure which obtains in the wheel wells. In the embodiment illustrated in FIGS. 1 and 2, the inlet 14 is disposed at a radiator opening at a fore portion 16 of the vehicle 10. However, in other embodiments, inlets may be suitably located in a number of locations. As nonlimiting examples, inlets in other embodiments may accepts ram air from the base of a vehicle windshield, from a hood scoop mounted in a vehicle hood, from a vehicle engine compartment, on a body underside, or any suitable combination of these and/or other locations.

In the embodiment illustrated in FIGS. 1, 2, and 3, a single duct 12 is associated with a front driver-side wheel well. Other similar ducts, not illustrated, may be associated with one or more of the other vehicle wheels. It will be appreciated that in some vehicles, it may be appropriate to employ individual inlets for each brake while in other vehicles the flow from a single inlet may be split and directed, via multiple ducts to a like multiplicity of brakes.

The inlet 14 may be a shaped member mounted on the outer surface of the vehicle body. The inlet 14 may be secured to and supported by the vehicle body or may be secured to a structural member underlying the vehicle body. The inlet 14 may serve to support the duct 12 or the duct 12 may be separately supported, e.g. on the vehicle structure. The inlet 14 may be fabricated of a suitable polymeric material and secured to the vehicle 10 by mechanical fasteners such as self-tapping screws, rivets, clips or other means well known to those skilled in the art. The inlet 14 is intended to smoothly redirect some of the airflow around the vehicle body and prepare the airflow, with minimal disturbance, for entry into the duct 12. The inlet 14 may be molded and shaped to generally conform to the vehicle's exterior contours and may be color-matched to the vehicle paint to foster an aesthetically-pleasing appearance. In some embodiments the inlet 14 may be integral with a molded vehicle body component or after-market accessory such as a splitter or an air dam. In some embodiments, the inlet 14 and duct 12 may be formed as a unitary body.

The duct 12 splits into an inboard portion 18 and an outboard portion 20. The inboard portion 18 extends to a first outlet 22 at an inboard portion of a wheel well. The first outlet 22 is positioned to discharge the airflow where it may serve to cool a vehicle brake caliper 26. In general, the brake, its associated wheel, and generally several suspension components will be partially enclosed in the wheel well. The inboard portion 18 extends into the inboard side of the wheel well so that air will flow, first through the inboard portion 18 and then the first outlet 22, to the wheel well and, preferably, be directed onto at least one of the vehicle brakes. The outboard portion 20 extends to a second outlet 24 at an outboard portion of a wheel well. The outboard portion 20 extends into the outboard side of the wheel well so that air will flow, first through the outboard portion 20 and then to the second outlet 24, to the wheel well and, preferably, form a wall of high speed air, referred to as an air curtain, outboard of vehicle wheels for the purposes of reducing drag.

A valve assembly 28, suited for directing air among the inboard portion 18 and outboard portion 20, is located in the inlet or the duct so that the flow of air to the wheel well or to the brakes may be provided only when required. The valve assembly 28 is under the control of a controller 30 in thermal communication with the brake via a thermal sensor 32. The controller 30 may control the valve assembly 28 in response to sensor readings from the thermal sensor 32. As will be discussed in further detail below, the controller 30 is generally configured to control the valve assembly 28 to direct air through the outboard portion 20 during normal operation, and to the inboard portion 18 when brake cooling is desired.

Referring now to FIG. 4, a schematic representation of a duct assembly according to embodiment of the invention is shown. It should be noted that while this assembly is illustrated for for a front driver-side wheel, similar duct assemblies may be provided for other vehicle wheels.

A vehicle wheel 34 is disposed in a wheel well 36. A disc rotor 38 is mounted generally concentrically with the wheel 34. A pair of brake pads 40 are configured to frictionally engage the rotor 38 to decelerate the vehicle. The brake pads 40 are carried by pistons 42, which are in turn slidably supported by the caliper 26. A fluid line 44 supplies fluid to the caliper 26, such that an increase in line pressure in the fluid line 44 causes actuation of the pistons 42 and, in turn, the brake pads 40. When frictionally engaged, the brake pads 40 and rotor 38 experience an increase in thermal energy.

A thermal sensor 46 is configured to detect the temperature of the caliper 26. In an exemplary embodiment, the thermal sensor 46 is configured to detect fluid temperature of fluid supplied by the fluid line 44. In other embodiments other sensors may be used, such as an infrared thermometer configured to detect temperature of the caliper 26.

The thermal sensor 46 is in communication with or under the control of the controller 30. The controller 30 is configured to control the valve system 28 based at least in part on temperature readings from the thermal sensor 46.

While depicted as a single unit, the controller 30 may include one or more other controllers collectively be referred to as a “controller.” The controller 30 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The valve assembly 28 includes an electromechanical actuator 48, which may comprise a solenoid. The electromechanical actuator 48 is configured to drive a blocker member 50 between a plurality of positions, including a cooling position and an air curtain position. In the cooling position, as illustrated in FIG. 4, the blocker member 50 is configured to at least partially inhibit airflow to the outboard portion 20, and thereby direct air to the inboard portion 18 to thereby cool the brake caliper 26. In the air curtain position, as illustrated by the dashed line in FIG. 4, the blocker member 50 is configured to at least partially inhibit airflow to the inboard portion 18, and thereby direct air to the outboard portion 20 to form an air curtain and decrease vehicle drag. The electromechanical actuator 48 may also be configured to position the blocker member 50 in one or more intermediate positions, in which a first portion of airflow is directed to the inboard portion 18 and a second portion of air is directed to the outboard portion 20.

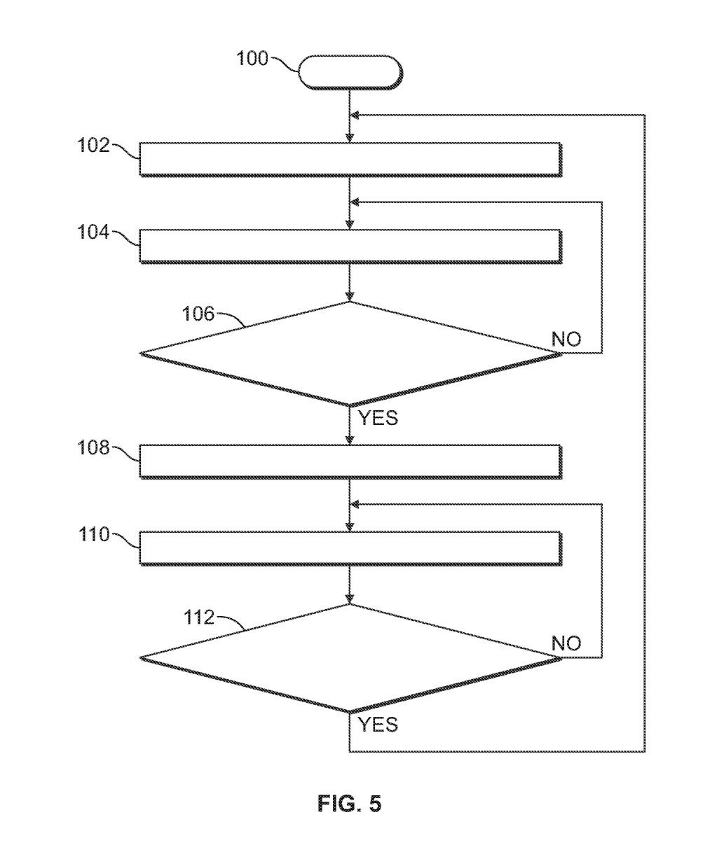

Referring now to FIG. 5, a method of controlling a duct system according to the present disclosure is illustrated in flow chart form. The method begins at block 100. In an exemplary embodiment, the method is performed by means of programming provided to a controller, e.g. the controller 30 illustrated in FIGS. 1 and 4.

The valve assembly is controlled to an air curtain position, as illustrated at block 102. As discussed above, in the air curtain position, airflow to the inboard portion of the duct is at least partially inhibited. In an exemplary embodiment, in the air curtain position, all airflow to the inboard portion is inhibited, and thus all airflow in the duct is directed through the second outlet to form an air curtain. However, in other embodiments, a portion of airflow may also be directed to the inboard portion to provide a baseline level of brake cooling.

A brake caliper temperature is detected, as illustrated at block 104. This may be performed, for example, by means of the thermal sensor 46 illustrated in FIG. 4.

A determination is made of whether the brake caliper temperature exceeds a first predefined threshold, as illustrated at operation 106. The first predefined threshold is based on a desired operating temperature range for the brake system and may be, for example, on the order of 1000 degrees Fahrenheit.

If the determination of operation 106 is negative, i.e. the detected caliper temperature does not exceed the first threshold, then control returns to block 104. The valve assembly is thereby maintained in the air curtain position unless and until a detected brake caliper temperature exceeds the first threshold.

If the determination of operation 106 is positive, i.e. the detected caliper temperature does exceed the first threshold, then the valve assembly is controlled to the cooling position, as illustrated at block 108. As discussed above, in the cooling position, airflow to the outboard portion of the duct is at least partially inhibited. In an exemplary embodiment, in the cooling position, all airflow to the outboard portion is inhibited, and thus all airflow in the duct is directed through the first outlet to cool the vehicle brake system.

The brake caliper temperature is detected, as illustrated at block 110. As discussed above, this may be performed by means of the thermal sensor 46 illustrated in FIG. 4.

A determination is made of whether the brake caliper temperature falls below a second predefined threshold, as illustrated at operation 112. The second predefined threshold may be equal to or different from the first predefined threshold. In an exemplary embodiment, the second predefined threshold is less than the first predefined threshold, to thereby avoid rapid cycling between the cooling and air curtain modes due to hysteresis.

If the determination of operation 112 is negative, i.e. the detected caliper temperature does not fall below the second threshold, control returns to block 110. The valve assembly is thereby maintained in the cooling position unless and until the detected brake caliper temperature falls below the second threshold.

If the determination of operation 112 is positive, i.e. the detected caliper temperature does fall below the second threshold, then control returns to block 102 and the valve assembly is controlled to the air curtain position.

Variations on the above are also contemplated within the scope of the present disclosure.

In an alternative embodiment, the electromechanical actuator is programmed to progressively vary the position of the valve assembly among a plurality of positions between the air curtain position and the cooling position, to thereby more gradually increase cooling as needed while maintaining the air curtain for drag reduction.

In another alternative embodiment, the valve assembly may include an actuator based on smart or active materials such as shape memory alloys (SMAs) or paraffins, rather than an electromechanical actuator controlled by a controller. These actuators may be operated in a passive mode, that is, without application of external power, and may operate reliably over many thousands or hundreds of thousands of cycles. Advantageously such actuators may also serve as temperature sensors. These actuators are responsive to changes in temperature and may be selected to move the valve assembly from the air curtain position to the cooling position only when the brake temperature achieves a predetermined elevated temperature. The changes occurring during a temperature rise may, with appropriate design of the actuator, be reversed on cooling. Hence, the inlet may be maintained in the cooling position for only as long as is needed to maintain the brake temperature within a preferred operating temperature range. In such embodiments, the vehicle may be maintained in the lower-drag air curtain position unless supplementary brake cooling air is required to control brake temperatures under particularly taxing braking conditions. The use of SMAs or paraffins is discussed, for example, in U.S. Pat. No. 8,678,426, the disclosure of which is hereby incorporated in its entirety.

In other alternative embodiments, the valve assembly may be moved between the various positions according to different logic than described above. For example, the valve assembly may be moved to the cooling position in response to any brake request, independent of a measured temperature. This may be done via a mechanical connection to the brake system, via logic provided to the controller, or by other means as appropriate. As another example, the controller may be programmed to monitor vehicle throttle requests and/or speed, and to control the actuator to move the valve assembly to the air curtain position in response to moderate acceleration and/or generally stable speeds.

As may be seen, the present disclosure provides a system and method for balancing drag reduction and brake cooling requirements for a performance automotive vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. An automotive vehicle comprising:
a body with a wheel well having an inboard portion and an outboard portion;
a duct inlet associated with the body and configured to receive airflow resulting from vehicle motion;
a first duct outlet disposed at the inboard portion of the wheel well;
a second duct outlet disposed at the outboard portion of the wheel well;
a duct having a branch portion, a first length coupling the duct inlet to the branch portion, a second length coupling the branch portion to the first duct outlet, and a third length coupling the branch portion to the second duct outlet;
a vehicle wheel disposed in the wheel well, wherein the first duct outlet is disposed inboard of the vehicle wheel and the second duct outlet is disposed outboard of the vehicle wheel; and
a movable member disposed in the duct and being movable between a first position and a second position, wherein in the first position a first fraction of the airflow is directed from the first length into the second length, and in the second position a second fraction of the airflow is directed from the first length into the second length.

2. The automotive vehicle of claim 1, further comprising an electromechanical actuator coupled to the movable member and configured to drive the movable member between the first position and the second position.

3. The automotive vehicle of claim 2, further comprising a vehicle brake assembly, a thermal sensor configured to detect a current temperature of the vehicle brake assembly, and a controller configured to control the actuator to move the movable member from the first position to the second position in response to the current temperature exceeding a first predefined threshold.

4. The automotive vehicle of claim 3, wherein the controller is further configured to control the actuator to move the movable member from the second position to the first position in response to the current temperature falling below a second predefined threshold.

5. The automotive vehicle of claim 4, wherein the second predefined threshold is less than the first predefined threshold.

6. (canceled)

7. A method of controlling an automotive vehicle, the method comprising:
providing the vehicle with a wheel well having an inboard portion and an outboard portion;
providing the vehicle with a vehicle wheel disposed in the wheel well;
providing the vehicle with a duct having an inlet opening to the exterior of the vehicle, a first outlet opening to the exterior of the vehicle at the inboard portion, and a second outlet opening to the exterior of the vehicle at the outboard portion, the first outlet and second outlet being in fluid communication with the inlet, wherein the first duct outlet is disposed inboard of the vehicle wheel and the second duct outlet is disposed outboard of the vehicle wheel;
receiving air via the inlet during vehicle motion;
directing a first fraction of the air to the second outlet; and
in response to satisfaction of an operating condition, directing a second fraction of the air to the second outlet, the second fraction being different from the first fraction.

8. The method of claim 7, further comprising providing a movable member in the duct, the movable member having a first position and a second position, wherein directing the second fraction of air to the second outlet includes moving the movable member from the first position to the second position.

9. The method of claim 8, further comprising providing an actuator associated with the movable member, wherein moving the movable member from the first position to the second position includes controlling the actuator to drive the movable member from the first position to the second position.

10. The method of claim 7, further comprising providing the vehicle with a brake assembly, wherein the operating condition includes a current temperature of the brake assembly exceeding a first predefined threshold.

11. The method of claim 10, further comprising, in response to the current temperature falling below a second predefined threshold, directing the first fraction of the air to the second outlet.

12. The method of claim 11, wherein the second predefined threshold is less than the first predefined threshold.

13. The method of claim 7, wherein the operating condition includes a brake request.

14. A duct assembly for a vehicle, comprising:
a first duct portion, a second duct portion, and a third duct portion;
a branch portion coupling the first duct portion to the second duct portion and the third duct portion;
an inlet coupled to the first duct portion and fluidly coupling the first duct portion to the exterior of the vehicle;
a first outlet coupled to the second duct portion and fluidly coupling the second duct portion to the exterior of the vehicle, the first outlet being disposed at an inboard portion of a wheel well inboard of a vehicle wheel;
a second outlet coupled to the third duct portion and fluidly coupling the third duct portion to the exterior of the vehicle, the second outlet being disposed at an outboard portion of the wheel well outboard of the vehicle wheel; and
a valve assembly associated with the branch portion and configured to selectively vary a fraction of airflow from the first duct portion to the second duct portion.

15. The duct assembly of claim 14, wherein the valve assembly includes a movable member disposed at the branch portion and being movable between a first position and a second position, wherein in the first position a first fraction of airflow is directed from the first duct portion into the second duct portion, and in the second position a second fraction of airflow is directed from the first duct portion into the second duct portion.

16. The duct assembly of claim 15, wherein the valve assembly further includes an electromechanical actuator coupled to the movable member and configured to drive the movable member between the first position and the second position.

17. The duct assembly of claim 16, further comprising a controller configured to control the actuator to move the movable member from the first position to the second position in response to a measured temperature exceeding a first predefined threshold.

18. The duct assembly of claim 17, wherein the controller is further configured to control the actuator to move the movable member from the second position to the first position in response to the measured temperature falling below a second predefined threshold.

19. The duct assembly of claim 18, wherein the second predefined threshold is below the first predefined threshold.
